(19) United States
(12) Patent Application Publication
(10) Pub. No.: US 2003/0207440 A1
(43) Pub. Date: Nov. 6, 2003

(54) Decontamination of soil and groundwater

(76) Inventor: Keith L. Smith, Grantsville, UT (US)

Correspondence Address: JAMES L. SONNTAG, PARSONS BEHLE & LATIMER, P.O. BOX 45898, SALT LAKE CITY, UT, 84145, US

(21) Appl. No.: 10/239,264

(22) PCT Filed: Mar. 23, 2001
(86) PCT No.: PCT/US01/09506

(51) Int. Cl. C12S 5/00

(52) U.S. Cl. 435/266; 435/300.1; 210/747; 405/128.25; 405/128.3; 166/246

(57) ABSTRACT

A system and method for the accelerated decontamination of contaminated soil, vadose zone and/or groundwater is described. Contaminates are removed from soil and from the groundwater via heat injection through trenching or directionally drilled or horizontally drilled and installed delivery plumbing, pure oxygen injection through separate plumbing installed in the same manner as the plumbing used to deliver the heat, bioventing, sparging, and bioremediation, all through the oxygen delivery plumbing, and soil vapor extraction through vertical wells, all contained in one mobile treatment system. Contaminants are separated from the soil gas via filtration or oxidation. Residual contaminants in the vadose zone and/or the in the groundwater are subjected to volatilization by increased temperature via heat injection and/or oxidation via contaminant degrading microorganisms.

### RELATED APPLICATIONS

This application claims priority from patent application under the Patent Cooperation Treaty PCT/US 01/09506, filed Mar. 23, 2001, which claims priority from U.S. Provisional Patent Application No. 60/192,065, filed Mar. 24, 2000.

### STATEMENT REGARDING FEDERALLY SPONSORED RESEARCH OR DEVELOPMENT

(Not applicable)

### FIELD OF THE INVENTION

This invention relates to methods and systems for the accelerated decontamination of surface and/or subsurface regions with contaminated soil and/or contaminated groundwater.

### BACKGROUND OF THE INVENTION

Contamination of soil and groundwater is a significant environmental hazard. Environmental and health concerns, as well as the need to comply with environmental laws and regulations, necessitate the use of methods and systems for the decontamination of soil and groundwater. Currently used decontamination systems are costly, time consuming and/or inadequate.

There are many conventional techniques for the removal of contaminants from soil, or from the vadose zone, or from groundwater, such as air stripping, pump and treat, bioventing, etc. It is widely recognized that such systems are inadequate for the timely or rapid decontamination of contaminated soil, vadose zone, and/or groundwater. This is because these systems often require several years to achieve minimal cleanup goals. For example, air stripping is a technique where contaminated groundwater is pumped out of the subsurface and passed over a stripping column, which provides a water-air interface that allows for the diffusion of contaminants out of the water and into the air. Even at sites with relatively low levels of contaminants, this technique is often projected to take as many as thirty years at the cost of multimillions of dollars to achieve cleanup goals. The main reason why most conventional methods fail to achieve cleanup goals cost-efficiently and in a timely manner is because the delivery system utilized usually impacts only portions of contaminated plumes in the soil, vadose zone, and/or groundwater, thus leaving sections of the contaminated plumes to naturally attenuate.

It is, therefore, be an advance in the art to provide a system for decontamination of contaminated zones in soil, vadose zone, or groundwater, using a method for decontaminating contamination in soil, in the vadose zone and/or in the groundwater, which is more efficient and more economical than currently available methods. It would also be an advance to combine all of the advantages of multiple techniques for the decontamination of contaminated soil, vadose zone and/or groundwater into one mobile treatment system. It would also be an advance to enhance the effectiveness of all methods contained in the mobile treatment system through the accompanying injection of heat and pure oxygen, and deliver the decontamination inputs from the treatment system in such a manner as to impact much more of the contamination plumes than currently available methods impact.

### BRIEF SUMMARY OF THE INVENTION

The present invention provides for the accelerated removal of contamination from soil, the vadose zone, and/or groundwater. The contaminants are treated to render such less environmentally hazardous. The treatment involves vaporization and subsequent extraction, as well as oxidation and bioremediation. The products of the treatment system are less harmful, or not harmful to the environment, as compared to the contaminant, and thus the contaminant is deemed to have been treated to lessen an environmental hazard.

The present invention involves a method for removing contaminant from a matrix that comprises one or more of soil, a vadose zone, or a saturated zone. The method comprises the injecting an oxygen containing gas through at least one directionally, non-vertical disposed injection well passing through the matrix. The injection well or wells have a porous wall to enable the injection of the gas under positive pressure from the well into the matrix. Gas is then extracted from the matrix though at least one generally vertically disposed extraction well, the extraction well being under negative pressure and having a porous wall to enable the extraction of gas from the matrix into the extraction well. The injection well is disposed below contaminant material in the matrix to that as the gas rises through the matrix, gases produced in the matrix by interaction of the gas with contaminants are carried with the gas to the extraction wells. The injected oxygen containing gas to accelerates formation of gaseous or vaporized contaminant products that are carried along with the gas to the extraction well. The injection and extraction wells are disposed such that the zone through which the gas passes in the matrix between the injection well and the extraction well contains the contaminant material. The extracted gas it then treated to remove contaminant products in the gas derived from the contaminated material. The treated gas is then released into the atmosphere. The oxygen containing gas may be air, or may be oxygen enriched air, or comprise essentially pure oxygen. The gas contains sufficient oxygen to accelerate biodegradation and/or oxidative degradation of the contaminants.

The oxygen-containing gas may also contain microorganisms to introduce contaminant-degrading microorganisms into the matrix to accelerate biodegradation of the contaminant material and form gaseous degradation products to be carried away by the injected gas.

The oxygen-containing gas may also be heated to accelerate the volatilization of vaporized degradation products and warm the underground matrix and/or water to enhance biodegradation of the contaminant material to form gaseous degradation products. The heat may also be introduced into the saturated zone by withdrawing water from the saturated zone, heating the water, and reintroducing the heated water to the saturated zone.

As used herein, soil includes generally unconsolidated materials that are on the surface or below the surface. The vadose zone is that region between the surface and the water table. The saturated zone is below the water table where there is ground water.

As commonly understood in the industry, the soil is generally regarded as a separate zone. However, it is understood that there may be soil (unconsolidated materials) in the vadose and saturated zones, and contamination may extend onto that soil. Many hydrocarbons contaminants are lighter than water and generally float on the surface of the water table. However, there is some mixing at the interface of the water and the hydrocarbons, and soil in that area can become contaminated. Additionally, the water table in the subsurface fluctuates seasonally. As the water table raises and lowers floating contaminates can smear the soil. Therefore, at times of shallow water table fluctuations, there can be contaminated soil beneath the water table. Therefore, it is important to locate the injection lines beneath the zone of contamination based upon tests to characterize the plume.

Injection of the oxygen-containing gas results in residual soil gas containing contaminants. The soil gas is extracted through the extraction wells and is treated through a multitude of filtration methods, based upon site-specific conditions. For example, the removed contaminated soil gas can be passed through a vapor treatment system for injection into an aqueous medium, and subsequent separation through commonly available contaminant/water separators. Alternatively, the contaminated soil gas can be passed through granulated activated charcoal or some such other filter media for adsorption and subsequent disposal or treatment, or the contaminated soil gas can be oxidized through various methods such as thermal oxidation or ozonation. At any rate, any contaminated soil gas is decontaminated to below releasable levels as regulated by local statute before release to the atmosphere.

A feature of the present invention is an open circulated system so that the residual soil gas is not returned to the subsurface. By maintaining an open system, the effectiveness and cost-efficiency of treatment is increased. If the residual soil gas is returned to the soil the vadose zone, or the groundwater, as in certain prior-art methods, then there is that much more that must be treated over and over again. As an illustration, if 100 pounds of contaminant are present in one of the matrixes cited, and 20 pounds are removed via extraction system, then there are 80 pounds left in the matrix, if the 20 pounds extracted are treated separately and no portion thereof is returned to the matrix. If 10 pounds of it are returned or recirculated to the matrix, than there are still 90 pounds to treat. Additionally, if only non-contaminated air streams, atmospheric or pure oxygen in composition, are injected into the matrix, treatment efficiency rises due to an increase of electron acceptors for biodegradation in the soil, vadose zone, or groundwater, as well as due to simple dilutatory effects. An open circulated system is much more efficient than a closed circulated system.

In a preferred embodiment of the invention, the injection wells are placed at depths greater than the contamination zones/plumes, both parallel and perpendicular to the groundwater gradient and contaminant zone area. The vertical extraction wells are drilled in relation to specific flow characteristics of the soil and/or the vadose zone so as to extract resultant gases and vapors produced.

To accelerate the production of the gases and vapors, heated air is injected. The heat also increases the production of vapors produced by accelerated volatilization rates due to increased temperatures of soil and/or water from the heated air. In addition, an oxygen containing gas may be injected through a separate system. The oxygen-containing gas is enriched, or is pure oxygen to increase the bioremediation rates and production of gases produced therefrom.

The extracted gas is filtered and/or treated to reduce contaminant gasses and vapors to releasable levels as mandated by local regulations and released to the atmosphere, or otherwise treated and/or properly disposed of.

Contaminated Soil Remediation

Contaminated soil can be remediated by practice of the invention through the placement of directionally drilled injection wells throughout the soil profile, and one or more vertically drilled extraction well spaced in relation to the gas flow characteristics of the soil so as to extract vapors from the matrix, as well as gases introduced by the injection inputs. A positive pressure is induced in the injection wells, and a negative pressure is induced in the extraction wells. Injection inputs in the soil accelerate vaporization of contaminates. Vapors in the soil, originating either from the contaminate or induced through injection inputs in the soil, flow from the zones of high pressure induced by the positive pressure of the injection wells, to zones of low pressure induced by the negative pressure of the extraction wells.

Vadose Zone Remediation

A contaminated vadose zone is remediated by practice of the invention through the placement of directionally drilled injection wells throughout the soil profile, and one or more vertically drilled extraction wells spaced in relation to the soil gas flow characteristics of the vadose zone so as to extract vapors as well as gases induced by the injection inputs. A positive pressure is induced in the injection wells, and a negative pressure is induced in the extraction wells. Injected inputs in the soil, in the vadose zone, or in the groundwater accelerate vaporization of components in the contaminates. Vapors in the vadose zone, originating either from the contaminate or induced through injection inputs in the soil in the vadose zone, or groundwater, flow from the zones of high pressure induced by the positive pressure of the injection wells, to zones of low pressure induced by the negative pressure of the extraction wells.

Ground Water Remediation

Contaminated groundwater can be remediated by practice of the invention through the placement of directionally drilled injected wells below the zone of contamination and one or more vertically drilled extraction wells screened within a minimal distance above the most shallow depth of the groundwater and in relation to the soil gas flow characteristics of the vadose zone so as to extract vapors as well as gases induced by the injection inputs. A positive pressure is induced in the injection wells, and a negative pressure is induced in the extraction wells. Vapors in the soil or vadose zone, originating either from the contaminate or induced through accelerated volatilization of the contaminates caused by injection inputs in the vadose zone, or groundwater, flow from the zones of high pressure induced by the positive pressure of the injection wells, to zones of low pressure induced by the negative pressure of the extraction wells.

In an embodiment the invention, vertical water extraction wells are also drilled in relation to specific flow characteristics of the soil and screened in the area in-between impediment layers of inter-bedded varying soil textures so as to extract groundwater and thus capture gas from the injection wells and prevent such from moving laterally beyond the contaminant plume zone. The groundwater is then heated above the surface and re-injected to just below the most shallow area of the water table where vapors rising from such heated groundwater rise into the vadose zone and are extracted through the vertically drilled soil vapor extraction wells located therein. The extracted gases are then filtered and/or treated to releasable levels as mandated by local regulations and released to the atmosphere and/or treated and/or properly disposed of.

The extraction wells are normally vertically disposed but under certain conditions may be drilled horizontally. Extraction wells are horizontally disposed only under conditions that prevent vertical placement. For example, if contamination exists under a major road, it is not practical to vertically place the extraction wells under such circumstances. The same may be true if contamination exists under occupied commercial or residential buildings. Horizontal extraction wells may be more convenient than vertical extraction wells under such circumstances.

### BRIEF DESCRIPTION OF THE DRAWINGS

FIG. 1 is a flow sheet and schematic diagram showing an embodiment of the invention for the accelerated decontamination of contaminated soil, vadose zone, and/or groundwater.

FIG. 2 is a schematic diagram that more particularly shows the placement of injection and extraction wells in an embodiment of the present invention.

FIGS. 3A, 3B and 3C is another schematic diagram showing the movement of the pneumatic streams relative to the placement of injection and extraction wells in an embodiment of the present invention.

FIG. 4 depicts a system of the present invention showing the placement of wells in an embodiment as in FIG. 1.

### DETAILED DESCRIPTION OF THE INVENTION

The present invention is a system and method for the accelerated decontamination of soil, or the vadose zone, and/or groundwater. The accelerated decontamination involves the remediation of contaminants via extraction of contaminated vapors, as well as induced vaporization with subsequent extraction of contaminated vapors, as well as accelerated biodegradation of the contaminants. Contaminants may originate, for example, from leaking underground petroleum storage tanks used for gasoline, and/or diesel, and/or oil, and/or waste oil, and/or solvent storage, and/or other materials, or from spills from railroad tanker cars or freight truck trailers or large ocean going shipping vessels. Contaminants may also originate from leaking electrical transformers or from many other possible sources. Such contaminants may include one or more organic compounds such as benzene, toluene, xylenes, naphthalene, methyl tert butyl ether (MTBE), pentachlorophenol (PCP), polychlorinated biphenyls (PCB), poly aromatic hydrocarbons (PAHs), petroleum hydrocarbons, solvents, etc. These examples are illustrative, and the practical usages of this invention are not limited to these contaminants or strictly to organic contaminants. Scientific journals and technical publications are replete with articles and papers which identify contaminants of environmental concerns which can be remediated by the usage of the present invention.

Placement of Wells

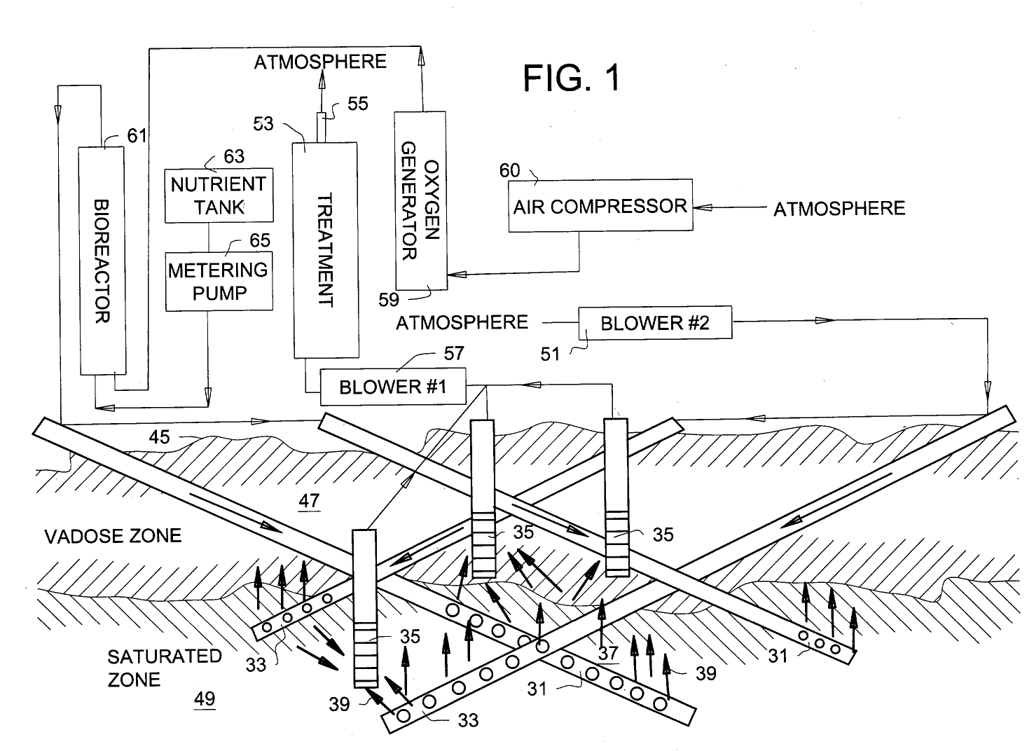

Reference is now made to FIGS. 1, 2, 3, and 4. A principle feature of the present invention involves the delivery through directional (non-vertical) injection wells 31, 33 of pneumatic injection inputs to surface soil or to the subsurface. Inputs injected via vertically drilled wells do not spread horizontally across a large area, but instead rise in the path of least resistance, most often straight up along the well bore. Commonly known pneumatic principles dictate that even in the presence of a vertically drilled extraction well exhibiting a negative pressure a pneumatic stream injected into a vertical injection well will rise straight up unless the negative pressure of the extraction well is great enough or close enough to overcome the resistance of the media into which the pneumatic stream is injected, or the media itself channels the pneumatic stream to the extraction well. This means that most often for communication between vertically drilled injection and extraction wells to be established, such wells have to be drilled so close together as to make usage of such cost-prohibitive due to the large numbers of wells required to treat a given contaminated area.

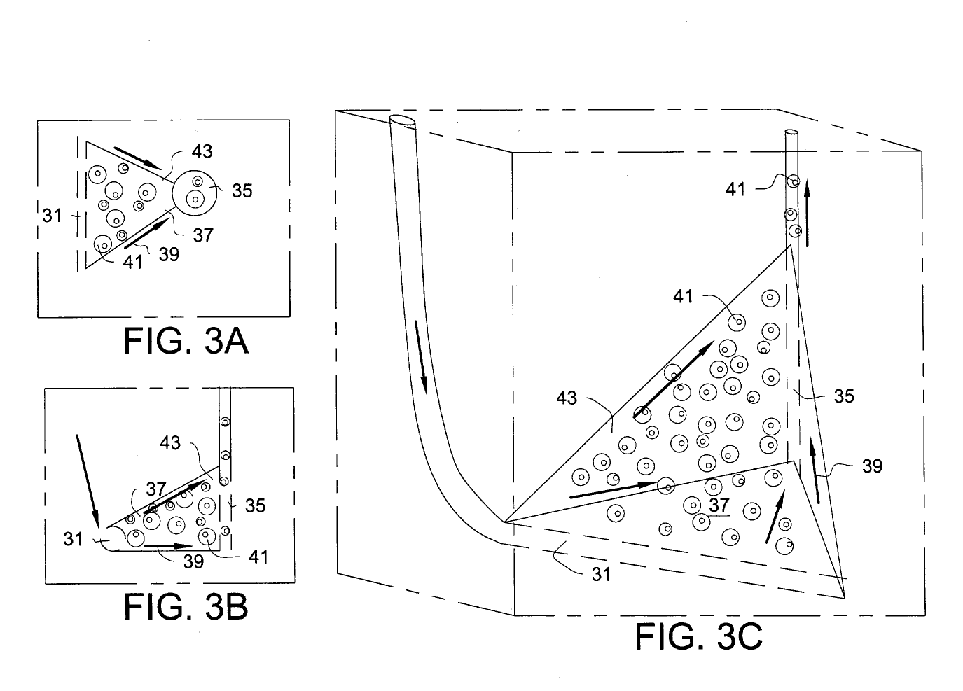

By utilizing directional, non-vertical or generally horizontal wells to inject the pneumatic inputs 31, 33 and one or more vertically drilled wells 35 to extract the soil gases, communication between extraction and injection wells is easily established. The injection inputs from the wells rise vertically along the horizontal plane of the injection line and are twisted toward the vertical plane of the extraction well when the pneumatic streams encounter the negative pressure of the vertically drilled extraction well. (See particularly FIG. 3.)

All well spacing is placed according to specific soil texture and porosity data at any given site, as well as according to contaminate spatial configuration in the soil, the vadose zone, and/or the groundwater. Injection or extraction wells used for the invention typically are drilled and constructed with annular space filled with filter media and capped at the surface with cement and bentonite. The filter media may extend along the entire length of the well, from the bottom of the well up to the cement or bentonite. The well screen is the porous portion of the well. The well screen is configured relative to contaminate location and soil water characteristics. In horizontal wells, the well screen is limited to that portion of the well line that levels off beneath the contamination. The reason for this is that horizontal, or directional drilling is often performed in a U shape. That is, the surface is penetrated and the drill bore is directed at an angle for a specific distance until the target depth is reached, whereupon the drill bore levels off for a specific targeted length, whereupon the drill bore angles back up toward the surface where it exits. The plumbing is pulled back through the borehole from that exit point. It is necessary to limit the portion of the plumbing that is porous (screened) to the section of the borehole that is horizontally level because if porosity is included in the angled approaches into and out of the soil, pneumatic inputs will all exit there, since air always travels to the highest section of the container. Therefore the section of plumbing used in the angled approaches is blank that is it is not perforated or screened. Only the horizontally level sections of the plumbing in the injection wells are screened. Additionally, if horizontal extraction wells are used, they can be “plugged,” i.e., plugs can be placed along the line in various areas to control the extraction points of the well.

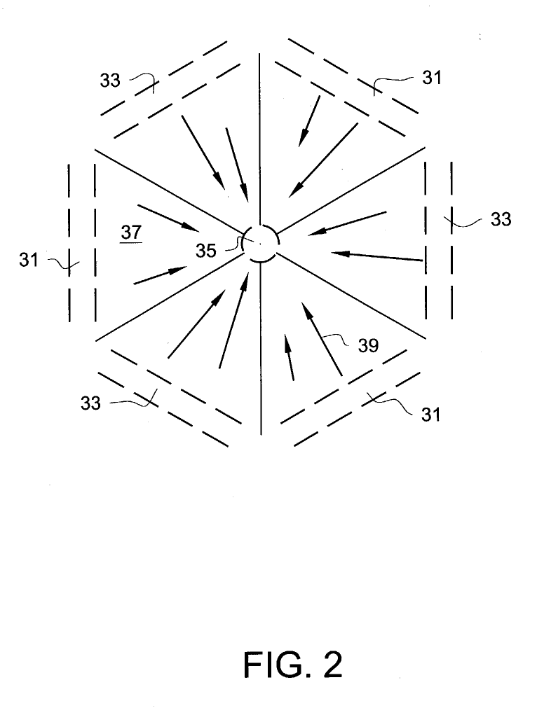

Reference is now made particularly to FIGS. 2 and 3. FIG. 2 shows a top view of six injection wells, 31, 33 surrounding an extraction well. Gas from the injection wells from the positive pressure is directed into and passes through the matrix 37, which may be soil, the vadose zone, or groundwater in the saturated zone. Because of the negative pressure on the extraction well 35, the gasses are directed toward the extraction well, as illustrated by the flow arrows 39.

Reference is now particularly made to FIG. 3A, FIG. 3B, and FIG. 3C, which show a single injection well 31 and a single extraction well 33 for simplicity. FIG. 3A is a top view, as in FIG. 2. FIG. 3B shows a side view of the same system. FIG. 3C shows the same system in a three-dimensional view. As shown, gas (shown as circles) 41 is injected from the injection well by positive pressure and directed through the matrix 37 toward the extraction well 35 (as shown by the flow arrows 39). As shown more clearly in FIG. 3C, the zone in which the gas flows forms a relatively large three-dimensional treatment zone 43 in the general form of a pyramid. If the injection well were vertical, the volume of the treatment zone would be much smaller, and resembling more a two-dimensional thin vertical plane. With the directionally aligned injection well 31, a large three-dimensional region can be defined to include contaminated zones. From this illustration it can be seen how placement of several directional injection wells with vertical extraction wells can be used to define a suitable three-dimensional region or regions, as dictated by the location of the contamination, and other matrix properties.

Reference is now made particularly to FIG. 1. Contaminants may be located in soil, in the vadose zone and/or in the groundwater zone. The vadose zone is the subsurface zone between the groundwater and the surface. Soil gas is drawn into extraction wells 35 from the surrounding soil or vadose zone due to the negative pressure generated by extraction blower 57. Soil gas extracted through wells is passed through a filtration unit in the treatment system 53 via lines running from the extraction wells 35 to the bottom of the treatment system 53.

The treatment system 53 serves as a means for adsorbing and/or rendering the soil gas from the extraction wells non-hazardous to the environment, so that it can subsequently be released through conduit 55. The soil gas, which contains products from biodegradation, oxidation, and volatilization of the contaminants in the soil, is introduced at the bottom of the filtration unit in the treatment system 53 so as to contact the maximum amount of surface area for most efficient adsorption residence time.

Injection inputs are obtained via two routes from the system. Atmospheric air is heated via passage through an injection blower 51, which has a heater capable of generating heated air with a temperature up to 350° F., and provides the positive pressure for injection into injection wells 33. The heated air stream from the blower 51 is introduced into the matrix 37 via directionally drilled injection wells 33. This heated air stream provides oxygen for electron acceptance for biodegradation of contaminants by indigenous bacteria and/or augmented bacteria. This heated air stream also stimulates bacterial degradation of contaminants through adjustment of the soil or vadose zone and/or groundwater temperatures to levels more optimum for bacterial metabolic processes. Injecting heat decreases the viscosity and increases the solubility of contaminants. This heated air stream also increases the rate of vaporization of the contaminants due to increased vaporization in the presence of increased temperature. Injecting heat into the saturated zone creates conduction and/or convection currents as the rising column of heated air removes contaminants from the water. Injecting heat makes the present invention much more efficient for the decontamination of contaminated soil 45, vadose zone 47, and/or groundwater 49 than currently available options. Heat can also be introduced into the groundwater zone 49 by withdrawing water, heating the water, and reinjecting the water as further described herein.

A second route of injected inputs through injection wells 31 supplied via an oxygen generator 59. The oxygen generator is fed by a compressor 60. The compressor 60 also provides the positive pressure required for injection of the gas through the injections wells 31. 92% pure oxygen is generated by the oxygen generator 59 and introduced into the soil 45 or vadose zone 47 and/or the groundwater 49 via directionally drilled wells 31 separate from those wells 33 used for the heated air stream. The 92% pure oxygen stream stimulates bacterial degradation of contaminants through providing a substantial increase of quantity of electron acceptors for oxidation of contaminants. It is calculated that it takes 2 pounds of oxygen to degrade 1 pound of hydrocarbon. One type of oxygen generator 59 utilized in the invention delivers 471 pounds of oxygen per day. Injecting 92% pure oxygen at relative high rates makes the invention much more efficient for the decontamination of contaminated soil 457 vadose zone 477 and/or groundwater 49 than currently available options.

The 92% pure oxygen can be first passed through a bioreactor 61. Such passage will impregnate the 92% pure oxygen stream with contaminant degrading bacteria and accompanying nutrients, and introduce both to the matrix 37. The microorganisms used in the bioreactor 61 can include any microorganisms effective for the biodegradation of the contaminants. Microorganism varieties can be chosen from market place sources or through literature research, or field collection. In addition to effective bacteria, other microorganisms, such as enzymatic agents which are effective for the biodegradation of contaminants can be used in the practice of the invention. The term “microorganism” is intended to be used to describe any enzyme produced by a microorganism, or any derivative from a microorganism, which is effective for the biodegradation of the contaminants.

Preferably the microorganisms utilized are aerobic contaminant degrading Pseudomonas spp. bacteria. Pseudomonas spp. bacteria are especially effective for the biodegradation of organic contaminants, such as benzene, toluene, xylenes, MTBE, PCBs, jet fuel, diesel, gasoline, oil, etc. Aerobic bacteria are active in the presence of oxygen. Such bacteria biodegrade the contaminants by metabolizing organic material to obtain energy to reproduce more bacteria. Carbon dioxide and water vapor are among the by-products of such biological processes. Some undigested solids may also remain after the process has ceased. The bacteria utilized are preferably pre-acclimated to the contaminants as carbon source. Pre-acclimation can be achieved via supporting the varieties of choice upon the targeted contaminant or contaminants for a period of time prior to introducing the bacteria to the matrix 37. The bacteria over time become dependent upon the contaminants as their sole carbon sources. Bacterial strains which can digest the contaminants in the matrix 37 thrive and will die from the contaminants. As a result of such pre-acclimation, strains can be supplied the matrix 37 which are especially effective for degradation of the targeted contaminants.

Nutrients and catalysts can be supplied the bacteria in the nutrient tank 63 as means for stimulating indigenous and/or augmented varieties for greater population growth and increased degradation rates. Nutrients and catalysts that specifically preferred by the microorganisms utilized are preferable. Catalysts which increase the metabolic rates and provide aleomorphic characteristics for the microorganisms utilized are preferable. The nutrients are metered from the nutrient tank 63 into the bioreactor by means of a metering pump 65.

Miscellaneous system components such as blowers 51, 57, nutrient tanks 63, metering pumps 65, oxygen generators 59, air compressors 60, etc. can be obtained from common commercial sources.

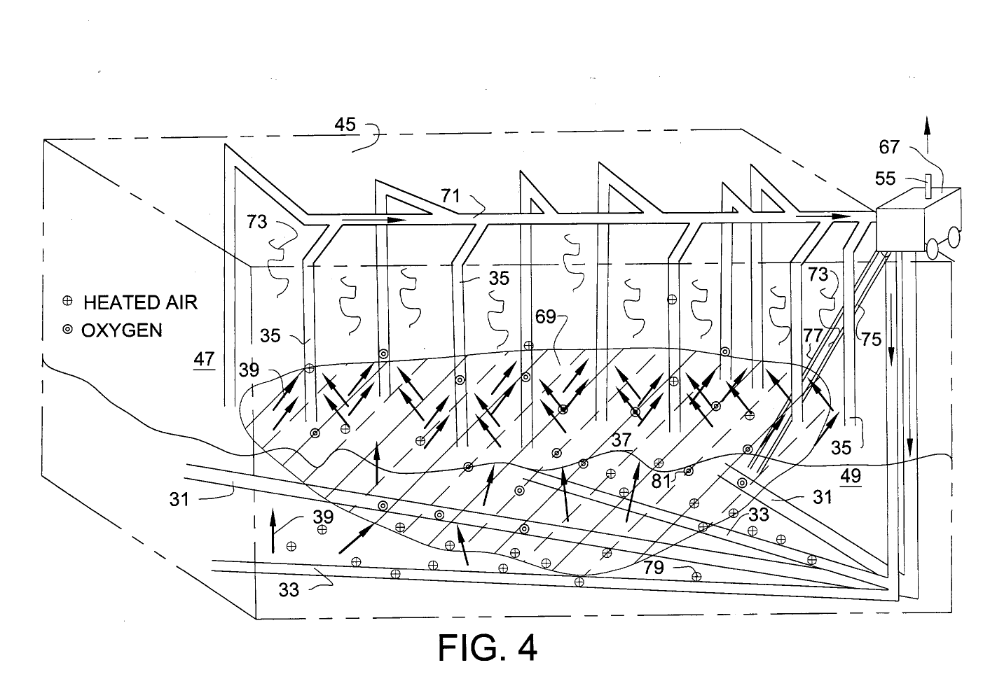

Reference is now made to FIG. 4. FIG. 4 illustrates how the system illustrated in FIG. 1, may be configured. The above ground equipment, such as the blowers 51, 57, filters 53, nutrient tanks 63, bioreactors 61, air compressors 60, oxygen generators 59, and the like are placed together in a single shelter 67, which may be mobile for movement from site to site. The injections wells 31, 33 are directed into and preferably under the zone of contamination 69. The vertical extraction wells 35 communicate with equipment in the shelter 67 by extraction lines 71 from the heads of vertically drilled wells. Heated air (shown by crossed circles 79) from the heated air injection wells 33 travels through the matrix 37, which in this illustration is a saturated zone 49, and vadose zone 47, toward the extraction wells 35. The heat also tends to spread through the matrix 37, carried by conduction and the flow of the gas and water, as illustrated by the wavy lines 73. The extraction wells 35 are disposed above the saturated zone 49, as it is not desired to draw water into the extraction wells.

In the second injection system, oxygen-enriched gas contains microorganisms (shown by O-circles 81) travels from injections wells 31, through the matrix 37, to the extractions wells 35. From the extraction wells 35 is drawn gas injected through the injection wells 31, 33, as well as gas products from the contaminants. The gas from the extractions wells 35 is passed through the treatment system 53 to remove harmful substances to safe concentrations and then is passed into the atmosphere though conduit 55. Accordingly, the only “product” of the system is a gas stream that has been treated to remove contaminants, and is ejected into the atmosphere.

The figures illustrate a preferred system with two injection systems, because bacteria in the preferred system are not compatible with air heated to a temperature greater than 110° F. However, it is contemplated that only one injection system or any number of injection systems be used, depending upon the nature of the treatment. For example, applying heat may not be required in some locations, where a separate injection system of heated air can be avoided. In addition, other treatment systems which are not compatible can be injected separately as required.

An alternate embodiment is also shown in FIG. 4. In addition to the gas/vapor extraction wells described above, a water extraction well 75 is provided to draw water from the contaminated zone 69 in the saturated zone 49. This may be desired to prevent the plume of contaminants in the water from spreading laterally through a water porous layer between two impediment or non-porous layers. The water is then heated by apparatus in the shelter 67 and injected through a water injection well 77. The heat from the water accelerates the production of vapor and improves the temperature of the matrix for biodegradation the same way as the heat introduced by heated gas.

The foregoing description of the invention and the accompanying drawings so fully reveal the combination of methods, the specialized delivery system and the unique heat and oxygen inputs, and the general nature of the invention, including its advantages and modifications, that anyone could readily modify the invention and/or adapt it for various applications without departing from its general concepts. Therefore, such adaptations and modifications should be, and are intended to be comprehended within the meaning and range of the claims appended hereto and their equivalents, which claims define subject matter regarded to be the invention described herein.

What is claimed is:

1. A method for removing contaminant from a matrix that comprises one or more of soil, a vadose zone, or a saturated zone, the method comprising:
injecting an oxygen containing gas through at least one directionally, non-vertical disposed injection well passing through the matrix, the injection well having a porous wall to enable the injection of the gas under positive pressure from the well into the matrix,
extracting the gas from the matrix though at least one generally vertically disposed extraction well, the extraction well being under negative pressure and having a porous wall to enable the extraction of gas from the matrix into the extraction well,
the injection well disposed below contaminant material in the matrix,
the injection well and the extraction well being disposed such that the zone through which the gas passes in the matrix between the injection well and the extraction well contains the contaminant material to allow the oxygen containing gas to accelerate formation of gaseous or vaporized contaminant products that are carried along with the gas,
treating the gas after extraction to remove from the gas harmful products in the gas that were derived from the contaminated material,
ejecting the contaminant depleted gas into the ambient atmosphere.

2. The method of claim 1 wherein the oxygen containing is air.

3. The method of claim 1 wherein the oxygen containing gas is oxygen enriched with respect to atmospheric air to accelerate biodegradation of the contaminant material to form gaseous degradation products.

4. The method of claim 3 wherein the oxygen containing gas consists essentially of oxygen.

5. The method of claim 1 wherein the oxygen containing gas contains contaminant degrading microorganisms to accelerate biological degradation of the contaminant material to form gaseous degradation products.

6. The method of claim 1 wherein the oxygen containing gas is air heated to accelerate the volatilization of vaporized degradation products and biodegradation of the contaminant material to form gaseous degradation products.

7. The method of claim 1 additionally comprising extracting water through water extraction wells extending into a saturated zone in the matrix, heating the water and returning the water to the saturated zone.

8. The method of claim 7 wherein the water extraction well is disposed and constructed such that it is screened in the area between impediment layers of inter-bedded varying soil textures, such that the water extracted by the extraction well captures and prevents gas in the water from moving laterally beyond contaminant-containing regions in the saturated zone.

9. An apparatus for removing contaminant from a matrix that comprises one or more of soil, a vadose zone, or a saturated zone, the apparatus comprising:
at least one directionally, non-vertical disposed injection well passing through the matrix
positive pressurization apparatus for injecting an oxygen containing gas into the matrix through the injection well, the positive pressurization apparatus for applying a positive pressure and the injection well having a porous wall to enable the injection of the gas under positive pressure from the well into the matrix,
at least one generally vertically disposed extraction well
negative pressurization apparatus for extracting the gas from the matrix, the negative pressurization apparatus for applying a negative pressure and the extraction well having a porous wall to enable the extraction of gas from the matrix into the extraction well,
the injection well disposed below contaminant material in the matrix,
the injection well and the extraction well being disposed such that the zone through which the gas passes in the matrix between the injection well and the extraction well contains the contaminant material to allow the oxygen containing gas to accelerate formation of gaseous or vaporized contaminant products that are carried along with the gas,
treating apparatus for treating the gas after extraction to remove from the gas harmful products in the gas that are derived from the contaminated material,
conduit for ejecting the contaminant depleted gas into the ambient atmosphere.

10. The apparatus of claim 9 wherein the oxygen containing is air.

11. The apparatus of claim 9 wherein the oxygen containing gas is oxygen enriched with respect to atmospheric air to accelerate biodegradation of the contaminant material to form gaseous degradation products.

12. The apparatus of claim 11 wherein the oxygen containing gas consists essentially of oxygen.

13. The apparatus of claim 9 wherein the oxygen containing gas contains contaminant degrading micro-organisms to accelerate biodegradation of the contaminant material to form gaseous degradation products.

14. The apparatus of claim 9 wherein the oxygen containing gas is air heated to accelerate the volatilization of vaporized degradation products and biodegradation of the contaminant material to form gaseous degradation products.

15. The apparatus of claim 9 additionally comprising extracting water through water extraction wells extending into a saturated zone in the matrix, heating the water and returning the water to the saturated zone.

16. The apparatus of claim 15 wherein the water extraction well is disposed and constructed such that it is screened in the area between impediment layers of inter-bedded varying soil textures, such that the water extracted by the extraction well captures and prevents gas in the water from moving laterally beyond contaminant-containing regions in the saturated zone.
